(19) United States
(12) Patent Application Publication
(10) Pub. No.: US 2024/0062073 A1
(43) Pub. Date: Feb. 22, 2024

(54) RECONSTRUCTION OF TRAINING EXAMPLES IN THE FEDERATED TRAINING OF NEURAL NETWORKS

(71) Applicant: Robert Bosch GmbH, Stuttgart (DE)

(72) Inventor: Andres Mauricio Munoz Delgado, Schoenaich (DE)

(21) Appl. No.: 18/447,445

(22) Filed: Aug. 10, 2023

(30) Foreign Application Priority Data
Aug. 19, 2022 (DE) 10 2022 208 614.7

(51) Int. Cl. G06N 3/098; G06N 3/084

(52) U.S. Cl. CPC G06N 3/098; G06N 3/084

(57) ABSTRACT

A method for reconstructing training examples, with which a predefined neural network has been trained to optimize a predefined cost function. A quality function is provided, which measures for a training example to what extent it belongs to an expected domain or distribution of the training examples; a variable of a batch of training examples, with which the neural network has been trained, is provided; a gradient of the cost function ascertained according to parameters, which characterize the behavior of the neural network, is divided into a partition made up of components; from each component, a training example is reconstructed using the functional dependency of the outputs of neurons in the input layer of the neural network which receives the training examples from the parameters of these neurons and from the training examples; the reconstructions obtained are assessed using the quality function; the partition into the components is optimized.

### CROSS REFERENCE

The present application claims the benefit under 35 U.S.C. § 119 of German Patent Application No. DE 10 2022 208 614.7 filed on Aug. 19, 2022, which is expressly incorporated herein by reference in its entirety.

### FIELD

The present invention relates to the federated training of neural networks, in which multiple clients contribute to the training on the basis of local inventories of training examples.

### BACKGROUND INFORMATION

Training neural networks, which may be used, for example, as classifiers for images or for other measured data, require a large volume of training examples having sufficient variability. If the training examples contain personal data such as, for example, images of faces or vehicle license plates, the collection of training examples from a variety of countries that each have different data protection rules becomes legally problematical. Moreover, images or video data, for example, have a very large volume, so that the centralized collection requires a very high amount of bandwidth and memory space.

### SUMMARY

Thus, in the case of federated learning, it may be provided that the neural network is output by a central entity, i.e., in particular, by a central computer, to numerous clients, i.e., in particular, to further computers, which then train the network in each case using their local inventories and ascertain proposals for changes to the parameters of the network. These proposals are aggregated by the central entity to form a final update of the parameters. Clients and the central entity are connected here, in particular, via a communication network. The neural network may then be output by the central entity to the clients via the communication network.

In this way, only parameters of the neural network and the changes thereto are exchanged between the central entity and the clients, in particular, exchanged via the communication network. The other side of this coin is that the control of the quality of the final training success is sacrificed to a certain extent.

The present invention provides a method for reconstructing training examples x, with which a predefined neural network has been trained to optimize a predefined cost function L. The cost function L is known to all participants, in particular, during the federated training.

Within the scope of the method of an example embodiment of the present invention, a quality function R is initially provided. Regardless of however a reconstructed training example \tilde{x} has been obtained, this quality function R measures for this reconstructed training example \tilde{x} to what extent it belongs to an expected domain or distribution of the training examples. The quality function R thus outputs a score, which indicates how well the reconstructed training example \tilde{x} fits into the expected domain or distribution. Thus, the goal of the reconstructed training example \tilde{x} fitting in there, accessible for an optimization, is in keeping with the maxim of Archimedes that it is possible to move any load when only one purchase point for a lever is present.

A variable B of a batch of training examples x, with which the neural network has been trained, is also provided. In the case of federated training, which is carried out by a plurality of decentralized clients C (where a decentralized client may be, in particular, a decentralized computer) and which is coordinated by a central entity Q (where the central entity may be, in particular, a central computer), B is usually either predefined by the central entity Q or is communicated by the clients C in each case to the central entity Q. If B is not known, an estimation may instead be used and the refinement of this estimation may be incorporated into the optimization described below.

The variable B is used in order to divide a gradient dL/dM_{w} of the cost function L according to parameters M_{w}, which characterize the behavior of the neural network, into a partition made up of B components Pⱼ. The gradient dL/dM_{w} in the case of federated learning is typically that which is reported by clients C back to a coordinated central entity Q. The partition may, for example, be implemented as a sum, for example, according to

$${\sum }_{j = 1 , … , B} \frac{1}{B} {P}_{j} = \frac{dL}{{dM}_{W}}$$

From each component Pⱼ of the gradient L/dM_{w}, a training example \tilde{x}ⱼ^{T} is reconstructed using the functional dependency of the outputs yᵢ of neurons in the input layer of the neural network which receives the training examples x from the parameters M_{w,i} of these neurons and from the training examples x. As will be explained in greater detail below, such a reconstruction is possible given the simplifying assumption that a single training example x activates at least one neuron in the input layer.

Such a reconstruction presupposes that the gradient dL/dM_{w} of the cost function L dating from this training example x is known. In the case of federated learning, however, a gradient dL/dM_{w} is typically reported back, which is aggregated via all B training examples of the batch, so that from this no direct conclusion regarding a single training example may be drawn. The method provided herein therefore carries out the reconstruction for each component Pⱼ of the gradient dL/dM_{w} separately and thereby attributes the problem to the task of finding the correct partition of the gradient dL/dM_{w} in components Pi.

For this purpose, according to an example embodiment of the present invention, the reconstructions \tilde{x}ⱼ^{T} obtained in each case for all components Pⱼ are assessed using the quality function R. The partition into the components Pⱼ is then optimized with the aim of improving their assessment via the quality function R upon renewed division of the gradient of the cost function and reconstruction of new training examples \tilde{x}ⱼ^{T}.

Thus, in the area of possible partitions of the gradient dL/dM_{w} into components Pⱼ, that partition is sought which, if according to this partition per component Pⱼ a reconstruction \tilde{x}ⱼ^{T} of a training example is generated, results in such reconstructions \tilde{x}ⱼ^{T}, which belong to the expected domain or distribution of the training examples. Thus, merely prior knowledge regarding this expected domain or distribution is needed in order to reconstruct at least approximately each individual training example x₁, . . . , x_{B}.

An only even approximate reconstruction that does not have the best quality already provides valuable clues to the quality of the training. For example, it may, in particular, be checked whether the correct type of training examples x as predefined by the central coordinating entity Q has even been used. If, for example, a neural network that classifies or otherwise processes images of traffic situations is trained, for example, for a driving assistance system or for a motor vehicle driving in an at least semi-automated manner, training examples of traffic situations are needed that have been recorded from the perspective of a motor vehicle. One of the clients could now, for example, misinterpret the instruction to collect training examples and utilize training examples that have been recorded using the helmet camera of a cyclist. The introduction of these training examples could ultimately worsen rather than improve the performance of the neural networks intended for motor vehicles. Such errors may be discovered also by an imperfect reconstruction.

In one particularly advantageous embodiment of the present invention, portions pⱼ·dL/dM_{w} with weights pⱼ and Σⱼpⱼ=1 are selected as components Pⱼ of the partition. For the values of the weights Pⱼ, 0<pⱼ<1 is then applicable, which is advantageous for the numerical optimization.

In one further advantageous embodiment of the present invention, a gradient of the quality function R is back-propagated to changes of the weights pⱼ. The proven gradient-based methods such as, for example, a stochastic gradient descent method, may then be utilized to discover the optimum.

The weights pⱼ may, for example, be initialized, in particular, using softmax values formed from logits of the neural network. These logits are raw outputs of a layer of the neural network and thus provide a first indication as to which of the training examples x in the batch have strongly contributed to the gradient dL/dM_{w}.

In one particularly advantageous embodiment of the present invention, a neural network is selected, which includes weights wᵢ^{T} and bias values bᵢ as parameters M_{w,i}. In such a network
an ith neuron multiplies a training example x fed to this neuron by weights wᵢ^{T},
the neuron adds a bias value bᵢ to the result in order to obtain an activation value of the neuron, and
the neuron ascertains an output yᵢ by applying a non-linear activation function to this activation value.

The activation value is then a linear function of the training example x. The activation function may, for example, be designed, in particular, in such a way that it is linear at least in sections. Thus, for example, the “Rectified Linear Unit (ReLU)” function passes on the positive portion of its argument unchanged.

If in the neural network the input layer of the neural network is immediately following by a dense layer, whose neurons are connected to all neurons of the input layer, the output yᵢ of the ith neuron is provided by

yᵢ=ReLU(wᵢ^{T}x+bᵢ),
so that for outputs yᵢ>0, the derivation may be:

$$\frac{dL}{{db}_{i}} = \frac{dL}{{dy}_{i}} \frac{{dy}_{i}}{{db}_{i}} = \frac{dL}{{dy}_{i}}$$

because dyᵢ/dbᵢ=1. Similarly applicable is

$$\frac{dL}{{dw}_{i}^{T}} = \frac{dL}{{dy}_{i}} \frac{{dy}_{i}}{{dw}_{i}^{T}} = \frac{dL}{{db}_{i}} {x}^{T} .$$

Thus, the reconstruction \tilde{x}^{T} of the training example x^{T} may be calculated as

$${\tilde{x}}^{T} = {( \frac{dL}{{db}_{i}} )}^{- 1} ( \frac{dL}{{dw}_{i}^{T}} )$$

under the condition also to be met by the neural network that (dL/dbᵢ)≠0.

As explained above, this calculation is carried out separately for each component Pⱼ of the gradient dL/dM_{w} in order to obtain in each case a reconstruction \tilde{x}ⱼ^{T}. Thus, gradients dL/dbᵢ of the cost function L according to the bias bᵢ and gradients dL/dwᵢ^{T} of the cost function L according to the weights wᵢ^{T} are ascertained from the component Pⱼ of the gradient dL/dM_{w}, and the reconstruction \tilde{x}ⱼ^{T} of the training example sought is ascertained from these gradients dL/dbᵢ and dL/dwᵢ^{T}. With progressive optimization of the partition of the gradient dL/dM_{w} into the components Pⱼ, the reconstructions \tilde{x}ⱼ^{T} are also constantly improved.

In one particularly advantageous embodiment of the present invention, a trained discriminator of a Generative Adversarial Network (GAN) is selected as quality function R. Such a discriminator has learned to differentiate genuine samples from the expected domain or distribution from samples generated using a generator of the GAN. The value of the quality function R used may, for example, be a classification score output by the discriminator. Probabilistic models, for example, may also be used, which make it possible to estimate density distributions of the training examples x via likelihood functions (for example, the Bayes models also utilized for the spam filtering of e-mails).

The training examples x may, for example, represent, in particular, images and/or time series of measured values. Images, in particular, are particularly large-volume and sensitive with respect to data protection, so that the federated training is particularly advantageous. Time series of measured data in industrial facilities accurate in every detail may also allow conclusions to be drawn about internals of a production process that are not intended for the general public. The reconstructed training examples \tilde{x}ⱼ^{T} are not quite so detailed and are thus less exploitable by unauthorized parties.

In one particularly advantageous embodiment of the present invention, the reconstructed training examples \tilde{x}ⱼ^{T} are fed to the neural network as validation data. The outputs subsequently provided by the neural network are compared with setpoint outputs, with which these reconstructed training examples (from an arbitrary source) are labeled. Based on the result of this comparison, it is ascertained to what extent the neural network is sufficiently generalized to unseen data. The reconstructed training examples \tilde{x}ⱼ^{T} are optimal test objects insofar as they are proven to belong to the domain or to the distribution of the original training examples x as evidenced by the quality function R, without being identical to any of these training examples x.

If this check indicates that the neural network is sufficiently generalized to unseen data, the network may be utilized in the intended active operation. The neural network is then advantageously fed measured data, which have been recorded with at least one sensor. An activation signal is ascertained from the output subsequently provided by the neural network. A vehicle, a driving assistance system, a system for quality control, a system for monitoring areas, and/or a system for medical imaging is/are activated with the activation signal. In this context, the reconstruction of training examples using the method provided herein ultimately offers an enhanced degree of certainty that the response to the activation signal executed by the respectively activated system is appropriate to the situation represented by the measured data.

Within the scope of the federated training, the reconstruction, as explained above, is advantageously carried out by a central entity Q, which distributes the neural network to a plurality of clients C for the purpose of federated training. The gradient dL/dM_{w} of the cost function L according to the parameters M_{w} is ascertained by a client C during the training of the neural network on a batch including B training examples x and aggregated via these B training examples x. As explained above, it may be checked in this way whether the contributions of all clients C are in fact meaningful with respect to the intended purpose of the neural network. The example was mentioned above, in which due to a misunderstanding between client C and central entity Q, training examples are used that are not suitable at all for the intended application. In addition, it is also possible, for example, that individual clients C constantly utilize training examples of a poor technical quality. For example, camera images may be incorrectly exposed and/or blurred so that the essentials of the images are undiscernible.

For example, a time development and/or a statistic may be ascertained via the reconstructed training examples \tilde{x}ⱼ^{T}. Upon further training using new training examples x, it is then possible, based on this time development and/or statistic, to detect a drift of the behavior of the neural network and/or a deterioration of the behavior of the neural network with respect to previous training examples x. Thus, for example, an incremental training of the neural network using continuously new batches of training examples could result in “knowledge” learned from previous training examples being “forgotten” again (so-called “catastrophic forgetting”).

Alternatively or also in combination to this, a control intervention in the cooperation between the central entity Q and the clients C may be carried out. This control intervention may, for example, have as its purpose to stop or to reverse a previously established deterioration or drift. A control intervention may, for example, include, in particular, temporarily or permanently disregarding the gradients dL/dM_{w} provided by at least one client C.

According to an example embodiment of the present invention, the method may be, in particular, wholly or partially computer-implemented. The present invention therefore also relates to a computer program including machine-readable instructions which, when they are executed on one or on multiple computers and/or compute instances, prompt the computer and/or compute instances to carry out the method described. In this sense, control units for vehicles and embedded systems for technical devices, which are also able to execute machine-readable instructions, may also be considered to be computers. Examples of compute instances are virtual machines, containers or serverless execution environments for the execution of machine-readable instructions in a cloud.

The present invention also relates to a machine-readable data medium and/or to a download product including the computer program. A download product is a digital product transferrable via a data network, i.e., downloadable by a user of the data network, which may be offered for sale, for example, in an on-line shop for immediate download.

Furthermore, a computer may be outfitted with the computer program, with the machine-readable data medium or with the download product.

Further measures improving the present invention are described in greater detail below with reference to figures, together with the description of the preferred exemplary embodiments of the present invention.

### BRIEF DESCRIPTION OF THE DRAWINGS

FIG. 1 shows an exemplary embodiment of method 100 for reconstructing training examples x, according to the present invention.

FIG. 2 shows an illustration of the reconstruction attributed to an optimization of components Pⱼ of a partition, according to an example embodiment of the present invention,

### DETAILED DESCRIPTION OF EXAMPLE EMBODIMENTS

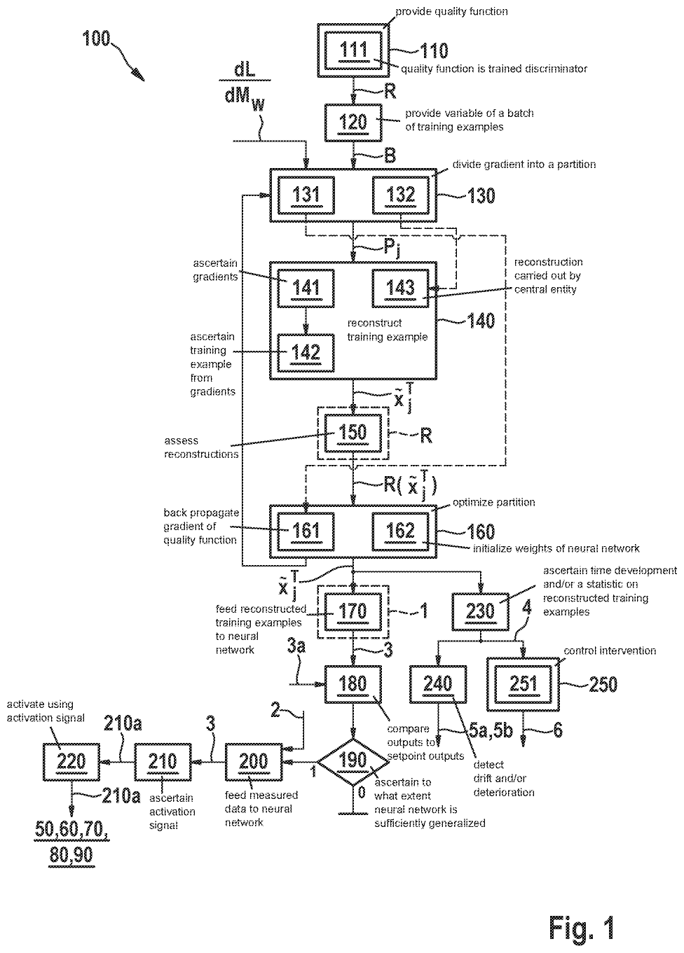

FIG. 1 is a schematic flowchart of one exemplary embodiment of method 100 for reconstructing training examples x, with which a predefined neural network 1 has been trained to optimize a predefined cost function L.

In step 110, a quality function R is provided, which measures for a reconstructed training example \tilde{x} to what extent it belongs to an expected domain or distribution of the training examples x. This quality function R according to block 111 may be a trained discriminator of a Generative Adversarial Network (GAN). As explained above, probabilistic models, for example, may also be used.

In step 120, a variable B of a batch of training examples x, with which the neural network has been trained, is provided.

In step 130, a gradient dL/dM_{w} of the cost function L ascertained during this training according to parameters M_{w}, which characterize the behavior of neural network 1, is divided into a partition made up of B components Pⱼ. In this case, portions pⱼ·dL/dM_{w} including weights pⱼ and Σⱼpⱼ=1, for example, may, in particular, be selected as components Pⱼ according to block 131.

From each component Pⱼ of the gradient dL/dM_{w}, a training example \tilde{x}ⱼ^{T} is reconstructed in step 140 using the functional dependency of the outputs yᵢ of neurons in the input layer of neural network 1 which receives the training examples x from the parameters M_{w,i} of these neurons and from the training examples x.

The parameters of the neural network may, for example, be, in particular, multiplicative weights wᵢ^{T} and additive bias values bᵢ, which are added to the training example x at the ith neuron in the input layer of neural network 1. According to block 141, gradients dL/dbᵢ of the cost function L according to the bias bᵢ and gradients dL/dwᵢ^{T} of the cost function L according to the weights wᵢ^{T} may be ascertained from the component Pⱼ of the gradient dL/dM_{w}. According to block 142, the reconstruction 5C′T of the training example sought may then be ascertained from these gradients dL/dbᵢ and dL/dwᵢ^{T}. As explained above, the activation function for this purpose should be a ReLU function, and the input layer of neural network 1 should be immediately followed by a dense layer. Furthermore, neural network 1 must ensure that (dL/dbᵢ)≠0.

According to block 143, the reconstruction may be carried out by a central entity Q, which distributes neural network 1 to a plurality of clients C for the purpose of federated training. This then involves that according to block 132 the gradient dL/dM_{w} is ascertained by a client C during the training of neural network 1 on a batch including B training examples x and is aggregated via these B training examples x.

In step 150, the reconstructions \tilde{x}ⱼ^{T} obtained are assessed using the quality function R.

In step 160, the partition into the components Pⱼ is then optimized with the aim of improving their assessment via the quality function R upon renewed division of the gradient dL/dM_{w} of the cost function L and reconstruction of new training examples \tilde{x}ⱼ^{T}.

According to block 161, a gradient of the quality function R may be back-propagated to changes of the weights pⱼ.

According to block 162, weights pⱼ may be initialized using softmax values formed from logits of neural network 1.

In step 170, the reconstructed training examples \tilde{x}ⱼ^{T} are fed to neural network 1 as validation data.

In step 180, outputs 3 subsequently provided by neural network 1 are compared with setpoint outputs 3a.

In step 190, it is ascertained based on the result of this comparison to what extent neural network 1 is sufficiently generalized to unseen data. This is classified as binary in the example shown in FIG. 1.

If neural network 1 is sufficiently generalized (truth value 1), measured data 2 that have been recorded using at least one sensor are fed to neural network 1 in step 200.

In step 210, an activation signal 210a is ascertained from output 3 subsequently provided by neural network 1.

In step 220, a vehicle 50, a driving assistance system 60, a system 70 for quality control, a system 80 for monitoring areas, and/or a system 90 for medical imaging is/are activated using activation signal 210a.

Reconstructed training examples \tilde{x}ⱼ^{T} may alternatively or in combination therewith be otherwise utilized. In step 230, a time development and/or a statistic 4 on reconstructed training examples \tilde{x}ⱼ^{T} is/are ascertained for this purpose. Based on this time development and/or statistic 4
a drift 5a of the behavior of neural network 1, and/or a deterioration 5b of the behavior of neural network 1 with respect to previous training examples x is/are detected in step 240 during further training with new training examples x, and/or
a control intervention 6 in the cooperation between central entity Q and the clients C is carried out in step 250.

According to block 251, control intervention 6 may include, for example, temporarily or permanently disregarding or underweighting, for example, by downscaling, gradients dL/dM_{w} provided by at least one client C.

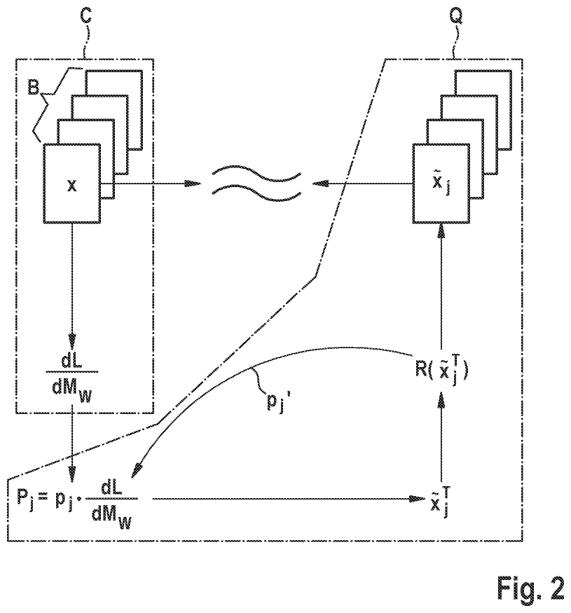

FIG. 2 illustrates the reconstruction in one application of the federated learning, in which a central entity Q distributes the neural network to a plurality of clients C. Each client C trains neural network 1 on a locally existing batch using B training examples x, ascertains the gradient dL/dM_{w} of the cost function L according to the parameters M_{w} and forwards this gradient dL/dM_{w} to the central entity Q.

The central entity Q disassembles the gradient dL/dM_{w} into a partition made up of components Pⱼ where j=1, . . . , B. A separate training example \tilde{x}ⱼ^{T} is reconstructed from each component Pⱼ. The reconstructed training examples \tilde{x}ⱼ^{T} are assessed using the quality function R. The weights pⱼ, with which the components pⱼ of the partition have been ascertained, are varied with the aim of improving the assessment R(\tilde{x}ⱼ^{T}) via the quality function R. If this iterative process is continued up to an arbitrary abort criterion, reconstructed training examples \tilde{x}ⱼ^{T} ultimately result, which are at least similar to the original training examples x and which belong to the domain or distribution of these training examples x.

What is claimed is:

1. A method for reconstructing training examples, with which a predefined neural network has been trained to optimize a predefined cost function, comprising the following steps:
providing a quality function, which measures for a reconstructed training example to what extent it belongs to an expected domain or distribution of the training examples;
providing a variable B of a batch of training examples, with which the neural network has been trained;
dividing a gradient dL/dM_{w} of the cost function ascertained during the training according to parameters which characterize a behavior of the neural network, into a partition made up of B components;
reconstructing, from each component of the gradient dL/dM_{w} of the cost function, a training example, using a functional dependency of outputs of neurons in an input layer of the neural network which receives the training examples from the parameters of the neurons and from the training examples;
assessing the reconstructions using the quality function; and
optimizing the partition into the components with an aim of improving their assessment via the quality function upon renewed division of the gradient dL/dM_{w} of the cost function and reconstruction of new training examples.

2. The method as recited in claim 1, wherein portions including weights pⱼ where Σⱼpⱼ=1 are selected as components of the partition.

3. The method as recited in claim 2, wherein a gradient of the quality function is back-propagated to changes of the weights pⱼ.

4. The method as recited in claim 2, wherein the weights pⱼ are initialized using softmax values formed from logits of the neural network.

5. The method as recited in claim 1, wherein the neural network includes weights wᵢ^{T} and bias values bᵢ as parameters M_{w,i}, wherein an ith neuron:
multiplies a training example x fed to the neuron by weights wᵢ^{T},
adds a bias value bᵢ to the result in order to obtain an activation value of the neuron, and
ascertains an output by applying a non-linear activation function to the activation value.

6. The method as recited in claim 5, wherein
gradients dL/dbᵢ of the cost function according to the bias bᵢ and gradients dL/dwᵢ^{T} of the cost function according to the weights wᵢ^{T} are ascertained from the component Pⱼ of the gradient dL/dM_{w}, and
the reconstruction of the training example sought is ascertained from the gradients dL/dbᵢ and dL/dwᵢ^{T}.

7. The method as recited in claim 1, wherein a trained discriminator of a Generative Adversarial Network (GAN) is selected as the quality function.

8. The method as recited in claim 1, wherein the training examples represent images and/or time series of measured values.

9. The method as recited in claim 1, further comprising:
feeding the reconstructed training examples to neural network as validation data;
comparing outputs subsequently provided by the neural network with setpoint outputs; and
ascertaining, based on a result of the comparison, to what extent the neural network is sufficiently generalized to unseen data.

10. The method as recited in claim 9, further comprising:
in response to the neural network being sufficiently generalized to unseen data, feeding the neural network measured data which have been recorded using at least one sensor;
ascertaining an activation signal from an output subsequently provided by the neural network; and
activating, using the activation signal: a vehicle, and/or a driving assistance system, and/or a system for quality control, and/or a system for monitoring areas, and/or a system for medical imaging.

11. The method as recited in claim 1, wherein:
the reconstruction is carried out by a central entity, which distributes the neural network to a plurality of clients for federated training, and
the gradient dL/dM_{w} from a client C is ascertained during the training of the neural network on a batch including B training examples and is aggregated via these B training examples.

12. The method as recited in claim 11, wherein
a time development and/or a statistic on the reconstructed training examples is ascertained and, based on the time development and/or statistic:
a drift of the behavior of the neural network, and/or a deterioration of the behavior of the neural network with respect to previous training examples is detected during the further training with new training examples, and/or
a control intervention in a cooperation between the central entity and the client is carried out.

13. The method as recited in claim 12, wherein the control intervention includes temporarily or permanently disregarding or underweighting the gradients dL/dM_{w} provided by the client.

14. A non-transitory machine-readable data medium on which is stored a computer program including machine-readable instructions for reconstructing training examples, with which a predefined neural network has been trained to optimize a predefined cost function, the instructions, when executed by one or multiple computers, causing the one or multiple computers to perform the following steps:
providing a quality function, which measures for a reconstructed training example to what extent it belongs to an expected domain or distribution of the training examples;
providing a variable B of a batch of training examples, with which the neural network has been trained;
dividing a gradient dL/dM_{w} of the cost function ascertained during the training according to parameters which characterize a behavior of the neural network, into a partition made up of B components;
reconstructing, from each component of the gradient dL/dM_{w} of the cost function, a training example, using a functional dependency of outputs of neurons in an input layer of the neural network which receives the training examples from the parameters of the neurons and from the training examples;
assessing the reconstructions using the quality function; and
optimizing the partition into the components with an aim of improving their assessment via the quality function upon renewed division of the gradient dL/dM_{w} of the cost function and reconstruction of new training examples.

15. One or multiple computers for reconstructing training examples, with which a predefined neural network has been trained to optimize a predefined cost function, the instructions, the one or multiple computers configured to:
provide a quality function, which measures for a reconstructed training example to what extent it belongs to an expected domain or distribution of the training examples;
provide a variable B of a batch of training examples, with which the neural network has been trained;
divide a gradient dL/dM_{w} of the cost function ascertained during the training according to parameters which characterize a behavior of the neural network, into a partition made up of B components;
reconstruct, from each component of the gradient dL/dM_{w} of the cost function, a training example, using a functional dependency of outputs of neurons in an input layer of the neural network which receives the training examples from the parameters of the neurons and from the training examples;
assess the reconstructions using the quality function; and
optimize the partition into the components with an aim of improving their assessment via the quality function upon renewed division of the gradient dL/dM_{w} of the cost function and reconstruction of new training examples.
